(19) United States
(12) Patent Application Publication
(10) Pub. No.: US 2026/0101089 A1
(43) Pub. Date: Apr. 9, 2026

(54) ELECTRONIC DEVICE AND CONTROLLING METHOD THEREOF

(71) Applicant: SAMSUNG ELECTRONICS CO., LTD., Suwon-si (KR)

(72) Inventors: Seungmin Choi, Suwon-si (KR); Sehyun Bae, Suwon-si (KR); Kwanki Ahn, Suwon-si (KR)

(73) Assignee: SAMSUNG ELECTRONICS CO., LTD., Suwon-si (KR)

(21) Appl. No.: 19/392,412

(22) Filed: Nov. 18, 2025

Related U.S. Application Data
(63) Continuation of application No. PCT/KR2025/015002, filed on Sep. 24, 2025.

(30) Foreign Application Priority Data
Oct. 7, 2024 (KR) 10-2024-0136084

(51) Int. Cl. H04N 21/466; H04N 21/431; H04N 21/45

(52) U.S. Cl. CPC H04N 21/4668; H04N 21/4312; H04N 21/4532

(57) ABSTRACT

An electronic device includes memory storing at least one instruction, and at least one processor. The at least one instruction, when executed by the at least one processor individually or collectively, causes the electronic device to: obtain first data corresponding to an access history of a first user for a plurality of contents that are classified according to a plurality of types, obtain second data corresponding to a plurality of attributes for each of the plurality of types, obtain first score information corresponding to a priority of each of the plurality of contents for the first user based on first probability information corresponding to an influence of each of the plurality of attributes on the first user, the first probability information being obtained by inputting the first data and the second data into a neural network model, and provide, on a display, at least one recommended content for the first user based on the first score information.

### CROSS-REFERENCE TO RELATED APPLICATIONS

This application is a continuation application of International application No. PCT/KR2025/015002, filed September 24, 2025, which is based on and claims priority to Korean Patent Application No. 10-2024-0136084, filed on October 7, 2024, in the Korean Intellectual Property Office, the disclosures of which are incorporated by reference herein in their entireties.

### BACKGROUND

### Field

The present disclosure relates to an electronic device and a controlling method of the electronic device, and more particularly, to an electronic device capable of providing recommended content to a user and a controlling method thereof.

### Description of Related Art

Recently, technologies that use artificial intelligence to recommend content suitable (e.g., personalized) for each user from a vast amount of content are being developed. For example, technologies that accurately analyze users' tendencies and interests using deep learning and reinforcement learning algorithms to provide customized content, technologies that combine various data sources to recommend content, and technologies that provide explanations for the reasons for recommending content are being developed continuously.

In particular, according to the related art, an artificial intelligence model can be used to identify the user's preferred attributes (e.g., genre, actor, etc.) by utilizing the user's access history to content, and content having the identified attributes can be recommended to the user.

However, since the related art technology does not consider how each attribute of the content affects the user's selection of content, there may be limitations in accurately analyzing the user's tendencies and interests to recommend content, and there may also be limitations in terms of the diversity of the content recommendations.

In addition, although the related art technology can recommend content by considering priorities among content of the same type, they have limitations in that it is difficult to recommend content suitable for the user by considering priorities among content of different types (e.g., video content and music content).

### SUMMARY

The present disclosure is to solve the problems of the related art as described above, and aims at providing recommended content suitable for a user by considering the influence of various attributes of content on the user.

According to an aspect of the disclosure, an electronic device includes: memory storing at least one instruction; and at least one processor operatively coupled to the memory, wherein the at least one instruction, when executed by the at least one processor individually or collectively, causes the electronic device to: obtain first data corresponding to an access history of a first user for a plurality of contents that are classified according to a plurality of types, obtain second data corresponding to a plurality of attributes for each of the plurality of types, obtain first score information corresponding to a priority of each of the plurality of contents for the first user based on first probability information corresponding to an influence of each of the plurality of attributes on the first user, the first probability information being obtained by inputting the first data and the second data into a neural network model, and provide, on a display, at least one recommended content for the first user based on the first score information.

The at least one instruction, when executed by the at least one processor individually or collectively, further causes the electronic device to provide the at least one recommended content such that the at least one recommended content is displayed on a user interface provided in the display according to an order of the priority based on the first score information.

The at least one instruction, when executed by the at least one processor individually or collectively, further causes the electronic device to obtain the first score information based on the priority of each of the plurality of contents for the first user without considering a priority of each of the plurality of types for the first user.

The first probability information includes (i) first probability values indicating the influence of each of the plurality of attributes on the first user and (ii) second probability values indicating an influence of each of a plurality of sub-attributes that distinguish each of the plurality of attributes on the first user; and in which the at least one instruction, when executed by the at least one processor individually or collectively, causes the electronic device to obtain the first probability values based on the second probability values for each of the plurality of attributes.

The neural network model is configured to, based on the first user accessing first content among the plurality of contents, obtain the first probability information based on increasing a probability value for at least one attribute corresponding to the first content.

The neural network model is configured to, based on the first content being recommended content provided based on one of the plurality of attributes, obtain the first probability information based on increasing the probability value for the at least one attribute corresponding to the first content.

The neural network model is configured to, by assigning a weight to the at least one attribute corresponding to the first content based on time information that is included in the first data and indicates a time of an access, obtain the first probability information.

The at least one instruction, when executed by the at least one processor individually or collectively, further causes the electronic device to: identify second probability information among probability information about each of a plurality of users having a similarity value with the first probability information that is equal to or greater than a threshold value; identify a second user corresponding to the second probability information among the plurality of users; and provide the at least one recommended content for the first user based on third data corresponding to an access history of the second user for the plurality of contents.

The at least one instruction, when executed by the at least one processor individually or collectively, further causes the electronic device to provide a type of content that is not included in the access history of the first user among the plurality of types as one of the at least one recommended content based on the third data.

The electronic device further includes communication circuitry, in which the at least one instruction, when executed by the at least one processor individually or collectively, further causes the electronic device to: control the communication circuitry to transmit information about the at least one recommended content to a user terminal of the user; and based on information about user feedback being received from the user terminal through the communication circuitry, train the neural network model based on the information about the user feedback.

The electronic device further includes: the display, in which the at least one instruction, when executed by the at least one processor individually or collectively, further causes the electronic device to: control the display to display a user interface including a plurality of objects corresponding to the at least one recommended content based on the first score information; and in which the plurality of objects are arranged according to an order of the priority within the user interface.

According to an aspect of the disclosure, a controlling method of an electronic device includes: obtaining first data corresponding to an access history of a first user for a plurality of contents that are classified according to a plurality of types; obtaining second data corresponding to a plurality of attributes for each of the plurality of types; obtaining first score information corresponding to a priority of each of the plurality of contents for the first user based on first probability information corresponding to an influence of each of the plurality of attributes on the first user, is the first probability information obtained by inputting the first data and the second data into a neural network model; and providing, on a display, at least one recommended content for the first user based on the first score information.

The providing recommended content comprises providing the at least one recommended content such that the at least one recommended content is displayed on a user interface provided in the display according to an order of the priority based on the first score information.

The obtaining the first score information comprises obtaining the first score information based on the priority of each of the plurality of contents for the first user without considering a priority of each of the plurality of types for the first user.

The first probability information comprises (i) first probability values indicating the influence of each of the plurality of attributes on the first user and (ii) second probability values indicating an influence of each of a plurality of sub-attributes that distinguish each of the plurality of attributes on the first user; and in which the obtaining the first probability information comprises obtaining the first probability values based on the second probability values for each of the plurality of attributes.

According to an aspect of the disclosure, a non-transitory computer readable medium, having instructions stored therein, which when executed by a processor in an electronic device cause the processor to execute a method including: obtaining first data corresponding to an access history of a first user for a plurality of contents that are classified according to a plurality of types; obtaining second data corresponding to a plurality of attributes for each of the plurality of types; obtaining first score information corresponding to a priority of each of the plurality of contents for the first user based on first probability information corresponding to an influence of each of the plurality of attributes on the first user, the first probability information obtained by inputting the first data and the second data into a neural network model; and providing, on a display, at least one recommended content for the first user based on the first score information.

The method further includes providing the at least one recommended content such that the at least one recommended content is displayed on a user interface provided in the display according to an order of the priority based on the first score information.

The method further includes obtaining the first score information based on the priority of each of the plurality of contents for the first user without considering a priority of each of the plurality of types for the first user.

The non-transitory computer readable medium as claimed in claim 16, wherein the first probability information comprises (i) first probability values indicating an influence of each of the plurality of attributes on the first user and (ii) second probability values indicating the influence of each of a plurality of sub-attributes that distinguish each of the plurality of attributes on the first user; and in which the method further includes obtaining the first probability values based on the second probability values for each of the plurality of attributes.

The neural network model is configured to, based on the first user accessing first content among the plurality of contents, obtain the first probability information based on increasing a probability value for at least one attribute corresponding to the first content.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating configuration of an electronic device briefly according to one or more embodiments;

FIG. 2 is a view provided to explain a neural network model and a plurality of modules according to one or more embodiments;

FIG. 3 is a view provided to explain a plurality of types and probabilities for each of a plurality of attributes according to one or more embodiments;

FIG. 4 is a view provided to explain a score for each of a plurality of contents according to one or more embodiments;

FIG. 5 is a view provided to explain a method of providing recommended content based on an access history of other users with similar probability information according to one or more embodiments;

FIG. 6 is a view provided to explain a user interface according to one or more embodiments;

FIG. 7 is a block diagram illustrating configuration of an electronic device in detail according to one or more embodiments; and

FIG. 8 is a flowchart illustrating a controlling method of an electronic device according to one or more embodiments.

### DETAILED DESCRIPTION

The embodiments of the present disclosure may be modified in various ways, and may have various embodiments, so specific embodiments are illustrated in the drawings and described in detail in the detailed description. However, it is to be understood that the disclosure is not limited to specific example embodiments, but include all modifications, equivalents, and/or alternatives according to example embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following example embodiments may be modified in several different forms, and the scope of the technical spirit of the disclosure is not limited to the following example embodiments. Rather, these example embodiments make the disclosure thorough and complete, and are provided to completely transfer the spirit of the disclosure to those skilled in the art.

Terms used in the disclosure are used only to describe specific example embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the expression, "at least one of A or B," should be understood as including only A, only B, or both A and B.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “~configured (or set) to” used in the disclosure may be replaced by an expression, for example, “suitable for,” “having the capacity to,” “~designed to,” “~adapted to,” “~made to,” or “~capable of” depending on a situation. A term “~configured (or set) to” may not necessarily mean “specifically designed to” in hardware.

Instead, an expression “~an apparatus configured to” may mean that an apparatus "is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In example embodiments, a ‘module’ or a ‘unit’ may perform at least one function or operation, and be implemented as hardware or software or be implemented as a combination of hardware and software. In addition, a plurality of ‘modules’ or a plurality of ‘units’ may be integrated into at least one module and be implemented as at least one processor except for a ‘module’ or a ‘unit’ that needs to be implemented as specific hardware.

Meanwhile, various elements and regions in the drawings are schematically drawn in the drawings. Therefore, the technical concept of the disclosure is not limited by a relative size or spacing drawn in the accompanying drawings.

Hereinafter, an embodiment according to the present disclosure will be described in detail with reference to the accompanying drawings so that a person with ordinary knowledge in the technical field to which the present disclosure belongs can easily implement the present disclosure.

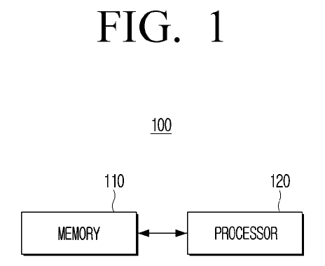

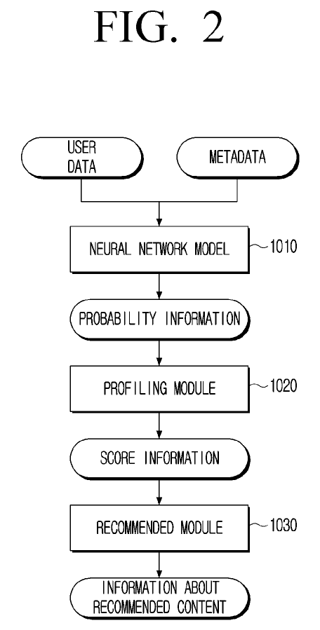

FIG. 1 is a block diagram illustrating configuration of an electronic device 100 briefly according to one or more embodiments. FIG. 2 is a view provided to explain a neural network model 1010 and a plurality of modules according to one or more embodiments. Hereinafter, various embodiments will be described with reference to FIG. 1 and FIG. 2 together.

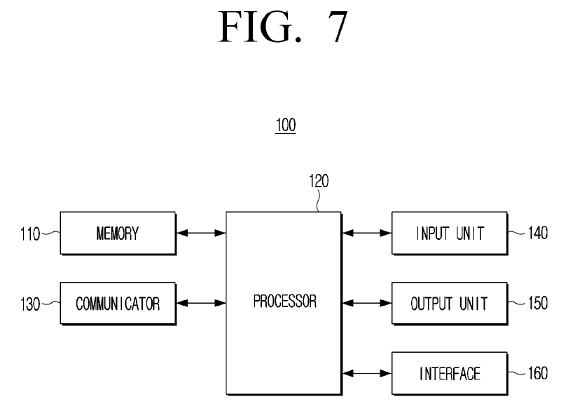

As illustrated in FIG. 1, the electronic device 100 may include memory 110 and at least one processor 120. However, the configurations illustrated in FIG. 1 are examples, and a more detailed configuration of the electronic device 100 will be described later with reference to FIG. 7.

The electronic device 100 according to the present disclosure refers to a device capable of providing recommended content to a user. In one or more examples, the electronic device 100 may provide recommended content suitable for a user by using the neural network model 1010.

For example, the electronic device 100 may be implemented as a server, in which case the electronic device 100 may obtain information about recommended content using the neural network model 1010 included in the electronic device 100 and transmit information about the recommended content to a user terminal. For another example, the electronic device 100 may be implemented as various devices such as a smart phone, a digital television, etc., in which case the electronic device 100 may include the neural network model 1010 as an on-device. There is no particular limitation on the type of the electronic device 100 according to the present disclosure.

At least one instruction regarding the electronic device 100 may be stored in the memory 110. In addition, an Operating System (O/S) for driving the electronic device 100 may be stored in the memory 110. Further, various software programs or applications for operating the electronic device 100 according to various embodiments of the present disclosure may be stored in the memory 110. In addition, the memory 110 may include a semiconductor memory such as a flash memory or a magnetic storage medium such as a hard disk.

Specifically, various software modules for operating the electronic device 100 according to various embodiments of the present disclosure may be stored in the memory 110, and the processor 120 may control the operation of the electronic device 100 by executing various software modules stored in the memory 110. For example, the memory 110 may be accessed by the processor 120, and reading/recording/modifying/deleting/updating, etc. of data may be performed by the processor 120.

In the present disclosure, the term ‘memory 110’ may be used to mean the memory 110, a ROM, a RAM in the processor 120, or a memory card (e.g., a micro-SD card, a memory stick) mounted in the electronic device 100.

In one or more embodiments, the memory 110 may store user data (e.g., first data and third data), second data (e.g., metadata), data for the neural network model 1010, probability information, score information, information about recommended content, etc. In addition, the memory 110 may store information about a user interface. Further, various information necessary within the scope of achieving the purpose of the present disclosure may be stored in the memory 110, and the information stored in the memory 110 may be updated as it is received from an external device or input by a user.

The processor 120 controls the overall operations of the electronic device 100. In one or more examples, the processor 120 is connected to the configuration of the electronic device 100 including the memory 110, and may control the overall operations of the electronic device 100 by executing at least one instruction stored in the memory 110 as described above.

The processor 120 may be implemented in various ways. For example, the processor 120 may be implemented as at least one of an application specific integrated circuit (ASIC), an embedded processor, a microprocessor, hardware control logic, a hardware finite state machine (FSM), or a digital signal processor (DSP). The term ‘processor 120’ in the present disclosure may be used to include a central processing unit (CPU), a graphic processing unit (GPU), and a microprocessor unit (MPU).

In one or more embodiments, the processor 120 may provide recommended content to a user using the neural network model 1010. As illustrated in FIG. 2, the processor 120 may implement various embodiments according to the present disclosure using the neural network model 1010, a profiling module 1020, and a recommendation module 1030. Hereinafter, various embodiments implemented by the processor 120 will be described.

The processor 120 may obtain first data corresponding to a first user's access history for a plurality of contents classified according to a plurality of types and second data corresponding to a plurality of attributes for each of the plurality of types. In one or more examples, the first data and the second data may be obtained from the memory 110 of the electronic device. In one or more examples, at least one of the first data or second data may be obtained from another electronic device or remotely from a server.

The first data and the second data may be obtained (or collected) and stored in the memory 110 whenever the data changes or at preset intervals. The processor 120 may obtain the first data and the second data by loading the first data and the second data stored in the memory 110 of the electronic device 100. The processor 120 may also obtain the first data and the second data by receiving the first data and the second data from an external device.

The plurality of 'contents' may be classified according to the plurality of 'types', and the plurality of types may be defined in various ways. For example, the plurality of types may include Video On Demand (VOD) content, broadcast content, music content, game content, art content, and the like. For another example, the plurality of types may include video content, photo content, music content, and the like. In addition, the plurality of types may be distinguished according to the type of service providing the content, the type of application providing the content, the content provider, etc. For example, the types of content may be distinguished based on whether the content is from a streaming service or is broadcast content.

A user's access history for a plurality of contents may indicate that the user has never accessed them. In other words, the plurality of contents do not mean that all contents have been accessed by the first user, and the term ‘a plurality of contents’ may refer to all contents included in a database that can be accessed by the electronic device 100.

The ‘user data' may collectively refer to data corresponding to (or indicating) a user's access history for a plurality of contents. Among the user data, the first data may specifically refer to data corresponding to a first user's access history for the plurality of contents. For example, the user data may include information about the time, number of times, frequency, etc. that the user accessed specific contents. The user's access may include viewing of contents, user input (e.g., touch input, click, etc.) for selecting or searching information about the contents, etc.

The 'second data' may collectively refer to data corresponding to (or indicating) attributes of a plurality of contents. Specifically, the second data may include metadata, and the metadata may indicate a plurality of attributes for each of a plurality of types. In other words, since the attributes of the contents may differ depending on the types of the plurality of contents, the second data may be built under different criteria for each type of contents. For example, when the contents are VOD contents, the plurality of attributes included in the second data may include genre, director, and cast. When the contents are music contents, the plurality of attributes included in the second data may include genre, composer/lyricist, and performer.

Depending on the embodiment, information about a plurality of 'sub-attributes' that distinguish each of the plurality of attributes may be included in the second data. For example, when the contents are VOD contents and the plurality of attributes include genre, director, and cast, the attributes called genre may be distinguished into various sub-attributes such as action, drama, horror, thriller, etc., and the attributes called director and cast may be distinguished into the names of various directors and cast.

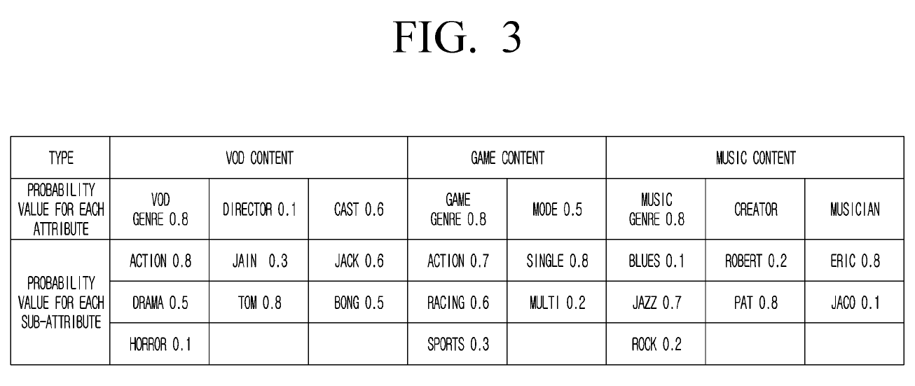

The term 'type' may be replaced with terms such as domain, category, class, etc. The term 'attribute' may be replaced with terms such as 'characteristic', 'item', etc., and the term 'sub-attribute' may be replaced with terms such as 'element', 'subitem', etc. Examples of types, attributes, and sub-attributes are described in greater detail with reference to FIG. 3.

The processor 120 may obtain first score information corresponding to the priority of each of the plurality of contents for the first user based on first probability information corresponding to the influence of each of the plurality of attributes on the first user, which is obtained by inputting the first data and the second data into a neural network model.

Specifically, the processor 120 may input the first data and the second data into the trained neural network model 1010 to obtain the first probability information indicating the influence of each of the plurality of attributes on the first user.

The 'neural network model 1010' refers to an artificial intelligence model that is trained to analyze the influence of each of various attributes related to content on a user. As illustrated in FIG. 2, when the user data and the second data are input, the neural network model 1010 may output the first probability information. Specifically, when the first data and the second data are input, the neural network model 1010 may obtain the first probability information based on to which of the plurality of attributes the first user's access to the plurality of contents corresponds. For example, the neural network model 1010 may include neural networks such as Convolutional Neural Networks (CNN), Recurrent Neural Networks (RNN), Long Short-Term Memory (LSTM), Feedforward Neural Networks (FFNN), and Transformers, but is not limited thereto.

The ‘probability information (or probability, probability value, etc.)' may collectively refer to information about the probability that indicates the influence of each of the plurality of attributes on the user. Among them, 'first probability information' may specifically refer to probability information that indicates the influence of each of the plurality of attributes on the first user. The probability information may include information indicating the user's preference for each of the plurality of attributes. The probability information may be updated whenever the user data or the second data is updated, and may also be updated at preset intervals.

The probability information may include a plurality of probability values, and among the plurality of probability values, the probability value of an attribute that has a great influence on the user's selection of content may be high, and the probability value of an attribute that has a small influence on the user's selection of content may be low. In one or more examples, since the probability values corresponding to each of the plurality of attributes indicate the user's individual (or independent) preference for each of the plurality of attributes, the sum of the probability values corresponding to each of the plurality of attributes does not have to be 1.

In one or more embodiments, the first probability information may include first probability values indicating an influence of each of the plurality of attributes on the first user, and second probability values indicating an influence of each of a plurality of sub-attributes that distinguish each of the plurality of attributes on the first user. In other words, the first probability information may include probability information about the plurality of sub-attributes as well as probability information about the plurality of attributes.

In this case, the processor 120 may obtain the first probability values based on the second probability values for each of the plurality of attributes. Specifically, the processor 120 may obtain the first probability values by synthesizing the second probability values for each of the plurality of attributes. For example, the term 'synthesizing' the second probability values may mean adding up or taking a weighted sum of the second probability values, but there is no limitation on the specific calculation method. Meanwhile, as described below, the first probability value may also be obtained in a method independent of the second probability value.

In one or more embodiments, when a first user accesses first content among a plurality of contents, the neural network model 1010 may obtain first probability information based on increasing a probability value for at least one attribute corresponding to the first content among the plurality of attributes. In other words, the neural network model 1010 may be trained to increase a probability value for an attribute corresponding to the content accessed by the user and thus, the neural network model 1010 may output a higher probability value for an attribute corresponding to specific content as the number of times or frequency of the user accessing the specific content increases.

In one or more embodiments, when the first user accesses the first content among the plurality of contents, and the first content is recommended content that is provided based on one of the plurality of attributes, the neural network model 1010 may obtain the first probability information based on increasing the probability value for the one attribute.

For example, when the first content is recommended content that is provided based on the attribute of director, the fact that the user accessed the first content may indicate that the user is influenced by the attribute of director. In particular, when information indicating that the first content is recommended based on director is provided together, the fact that the user accessed the first content may indicate that the user is greatly influenced by the attribute of director. Therefore, in this case, the neural network model 1010 may output a high probability value for the attribute of director.

In one or more embodiments, the neural network model 1010 may obtain the first probability information by weighting at least one attribute corresponding to the first content based on time information included in the first data and indicating the time of access.

For example, the first data may include time information about the time at which the first user accessed the first content and time information about the time at which the first user accessed the second content. In this case, when the time at which the first user accessed the first content is more recent than the time at which the first user accessed the second content, the processor 120 may assign a higher weight to the attribute corresponding to the first content than to the attribute corresponding to the second content.

As another example, the processor 120 may obtain the first probability information using only information about the history of the first user accessing the first content within a preset period (e.g., the past month).

The processor 120 may obtain first score information indicating a priority of each of the plurality of contents for the first user based on the first probability information. The processor 120 may obtain the first score information using the profiling module 1020.

The 'profiling module 1020' refers to a module that analyzes an influence of each of plurality of attributes on a user. As illustrated in FIG. 2, when probability information is input, the profiling module 1020 may obtain score information. The profiling module 1020 may be implemented as a neural network model trained to obtain score information when probability information is input. For example, the profiling module 1020 may be a second neural network model that receives the output of the neural network model 1010. Therefore, the configuration illustrated in FIG. 2 may include an interconnected network of neural network models.

The 'score information (or score, score value, etc.)' may collectively refer to information indicating s priority of each user of a plurality of contents. Among them, 'first score information' may specifically refer to information indicating a priority of each of a plurality of contents for the first user. The score information may be updated whenever probability information is updated, and may also be updated at preset intervals.

In one or more embodiments, the processor 120 may obtain the first score information indicating a priority of each of the plurality of contents for the first user by assigning a higher score to contents including more of the attributes/sub-attributes that the user considers more when selecting the contents, based on at least one of a probability value for each of the plurality of attributes or a probability value for each of the plurality of sub-attributes included in the first probability information.

In one or more embodiments, the processor 120 may obtain the first score information by using only the probability value for each of the plurality of sub-attributes, without using the probability value for each of the plurality of sub-attributes included in the first probability information. In addition, the processor 120 may obtain the first score information by using the probability value for each of the plurality of attributes together with the probability value corresponding to the sub-attribute having the highest probability value among the probability values for each of the plurality of sub-attributes included in the first probability information.

The processor 120 may provide at least one recommended content for the first user based on the first score information. The processor 120 may obtain the first score information using the recommendation module 1030.

The 'recommendation module 1030' refers to a module capable of analyzing recommended content to be provided to a user and obtaining information about the recommended content. As illustrated in FIG. 2, when score information is input, the recommendation module 1030 may output information about the recommended content. The recommendation module 1030 may be implemented as a neural network model trained to obtain information about the recommended content when score information is input.

The processor 120 may provide at least one recommended content by displaying at least one recommended content on a display included in the electronic device 100, and may provide at least one recommended content by transmitting information about the at least one recommended content to an external device such as a user terminal of the user. In particular, the processor 120 may provide at least one recommended content for the first user based on a priority of each of a plurality of contents included in the first score information.

In one or more embodiments, the processor 120 may identify (or determine) at least one recommended content for the first user based on the first score information, and provide the identified recommended content. For example, the processor 120 may identify a predetermined number of high-priority contents included in the first score information in a database for recommended content, and provide the identified contents as recommended content for the first user.

The processor 120 may not only identify recommended content according to the priority of the score information, but also sequentially provide recommended content or control the method in which recommended content is displayed according to the priority.

In one or more embodiments, the processor 120 may provide at least one recommended content so that the at least one recommended content is displayed in a priority order on the user interface based on the first score information. Here, the user interface may include not only what may be provided by the electronic device 100, but also what may be provided by an external device.

For example, when the score for the first content is 0.8 and the score for the second content is 0.6, the processor 120 may display the first content as recommended content within the user interface. When a user input denying access to the first content is received via the user interface, the processor 120 may display the second content as recommended content within the user interface.

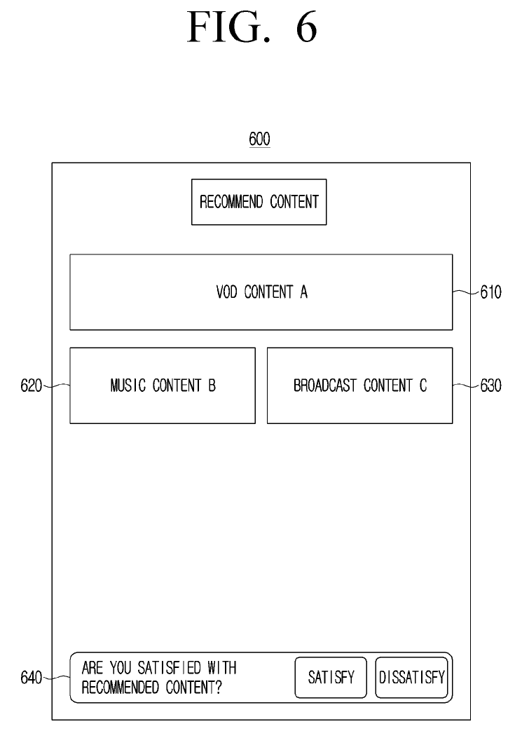

In the above example, the processor 120 may display the first content and the second content together as recommended content within the user interface, and may adjust the position of the first object corresponding to the first content to be higher or to the left than the second object corresponding to the second content. In this case, the processor 120 may adjust the size of the first object corresponding to the first content to be larger than the second object corresponding to the second content. The user interface will be described in greater detail with reference to FIG. 6.

According to the embodiments described above with reference to FIGS. 1 and 2, the electronic device 100 may provide recommended content suitable for the user by considering the influence of the attributes/sub-attributes of various contents on the user. Accordingly, the electronic device 100 may accurately analyze the user's tendencies and interests and recommend contents.

In addition, the electronic device 100 may use the attributes of contents as well as the influence of each sub-attribute on the user to recommend contents, and may also recommend contents to the user by considering the priority among different types of contents.

FIG. 3 is a view provided to explain a plurality of types and probabilities for each of a plurality of attributes according to one or more embodiments.

FIG. 3 is a table showing example probability information. As described above, the first probability information may include first probability values indicating the influence of each of a plurality of attributes on the first user, and second probability values indicating the influence of each of a plurality of sub-attributes that distinguish each of the plurality of attributes on the first user. FIG. 3 exemplarily shows a plurality of types, a plurality of attributes, and a plurality of sub-attributes according to the present disclosure, and exemplarily shows the first probability value for each of the plurality of attributes and the second probability value for the plurality of sub-attributes.

As shown in FIG. 3, the plurality of types may include VOD content, game content, and music content. Hereinafter, for convenience of explanation, the plurality of types will be limited to the three types in FIG. 3. Similarly, the plurality of attributes and the plurality of sub-attributes in FIG. 3 are only described as examples for convenience of explanation.

Referring to FIG. 3, the VOD content may include attributes such as VOD genre, director, and cast. The VOD genre may include sub-attributes such as action, drama, and horror, the director may include sub-attributes such as Jain and Tom, and the cast may include sub-attributes such as Jack and Bong.

Referring to FIG. 3, the game content may include attributes such as game genre and mode. The game genre may include sub-attributes such as action, racing, and sports, and the mode may include sub-attributes such as single and multi.

Referring to FIG. 3, the music content may include attributes such as music genre, creator, and performer. The music genre may include sub-attributes such as blues, jazz, and rock, the creator may include sub-attributes such as Robert and Pat, and the performer may include sub-attributes such as Eric and Jaco.

The numbers next to the attributes and sub-attributes in FIG. 3 indicate the first probability value for each attribute and the second probability value for each sub-attribute. Specifically, the numbers next to the attributes and sub-attributes in FIG. 3 may indicate the influence that each attribute and each sub-attribute has on the content selection of the first user.

For example, information such as VOD genre 0.8 and director 0.1 could indicate that the influence of VOD genre on the user (or the likelihood that user will select content based on his or her preference for VOD genre) is 8 times greater than the influence of director on the user. Information such as action 0.8 and drama 0.5 could indicate that the action genre has 8/5 times greater influence on the user’s content selection than the drama genre. Accordingly, a first attribute that has a higher influence than a second attribute may be weighted higher than the second attribute.

As described above, the sum of the probability values corresponding to each of the plurality of attributes does not have to be 1 because they indicate the user's individual (or independent) preference for each of the plurality of attributes.

In one or more embodiments, the processor 120 may obtain the first probability values by synthesizing the second probability values for a plurality of attributes. For example, 'synthesizing' the second probability values may mean summing or taking a weighted sum of the second probability values. However, the embodiments are not limited to this specific calculation method, and may include any calculation method known to one of ordinary skill in the art. Accordingly, the electronic device 100 may use the influence of each sub-attribute as well as attribute of contents on the user for recommendation of contents.

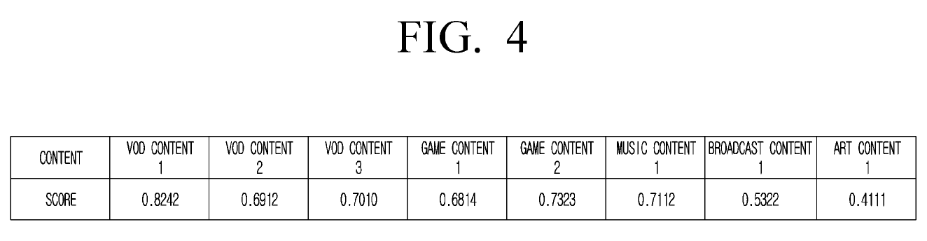

FIG. 4 is a view provided to explain a score for each of a plurality of contents according to one or more embodiments.

FIG. 4 is a table showing example score information. As described above, when the probability value for each of a plurality of attributes and the probability value for each of a plurality of sub-attributes are obtained as in FIG. 3, the processor 120 may obtain the first score information indicating the priority of each of a plurality of contents for the first user based on at least one of the probability for each of the plurality of attributes or the probability for each of the plurality of sub-attributes included in the first probability information. The processor 120 may assign a higher score to contents that include more attributes/sub-attributes that the user considers when selecting contents.

In one or more embodiments, the processor 120 may obtain the first score information by using only the probability value for each of the plurality of attributes included in the first probability information, without using the probability value for each of the plurality of sub-attributes included in the first probability information. In addition, the processor 120 may obtain the first score information by using the probability value for each of the plurality of attributes together with the probability value corresponding to the sub-attribute having the highest probability value among the probability values for each of the plurality of sub-attributes included in the first probability information.

As illustrated in FIG. 4, the score of VOD content 1 may be 0.8242, the score of VOD content 2 may be 0.6912, the score of VOD content 3 may be 0.7010, the score of game content 1 may be 0.6814, the score of game content 2 may be 0.7323, the score of music content 1 may be 0.7112, the score of broadcast content 1 may be 0.5322, and the score of art content 1 may be 0.4111. In this case, the processor 120 may provide recommended content in the order of VOD content 1, game content 2, music content 1, VOD content 3, VOD content 2, game content 1, broadcast content 2, and art content 3.

In other words, the processor 120 may obtain the first score information based on the priority of each of the plurality of contents for the first user without considering the priority of each of a plurality of types for the first user. In the example of FIG. 4, the average score of the VOD content type is 0.7388, the average score of the game content type is 0.7069, the average score of the music content is 0.7112, the average score of the broadcast content is 0.5322, and the average score of the art content is 0.4111. However, the processor 120 may not provide recommended content in the order of VOD content, music content, game content, broadcast content, and art content, but may provide recommended content in the order of VOD content 1, game content 2, music content 1, VOD content 3, VOD content 2, game content 1, broadcast content 2, and art content 3.

According to the embodiments described above with reference to FIG. 4, the electronic device 100 may provide recommended content by mixing various types of contents by recommending content to the user by considering the priorities among different types of contents without considering the priorities for the plurality of types.

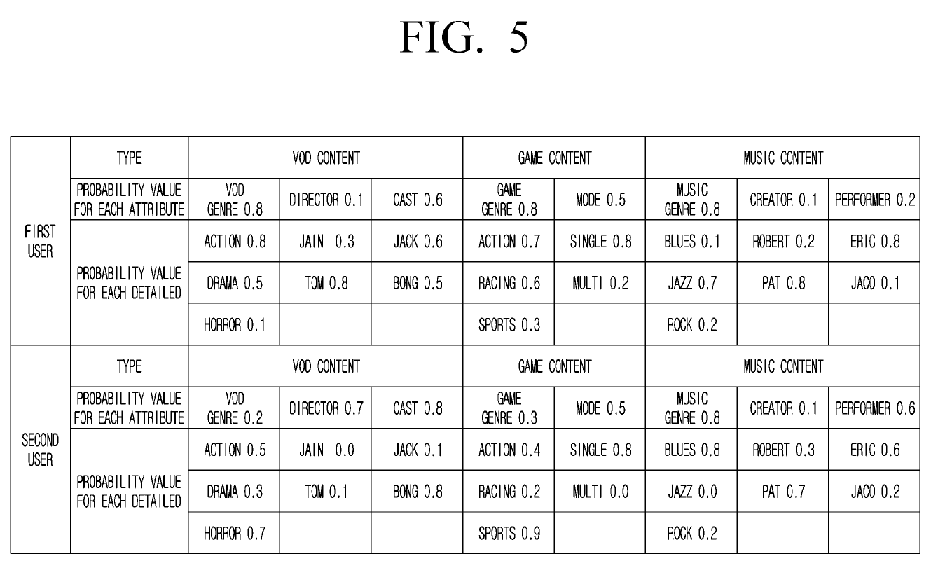

FIG. 5 is a view provided to explain a method of providing recommended content based on an access history of other users with similar probability information according to one or more embodiments.

The above has described embodiments for providing recommended content suitable for one user (e.g., the first user), but the electronic device 100 may provide recommended content for the first user by taking into account probability information about the first user and other users.

The probability information including the probability value for each of the plurality of attributes and the probability value for each of the plurality of sub-attributes may be obtained/updated/stored for each user. As illustrated in FIG. 5, the first probability information about the first user (same as illustrated in FIG. 3) may be different from the probability information about the second user.

The processor 120 may identify the second probability information having a similarity with the first probability information equal to or greater than a threshold value among probability information about each of a plurality of users, and may identify a second user corresponding to the second probability information among the plurality of users.

For example, the processor 120 may obtain a vector [0.8, 0.1, 0.6, 0.8, 0.5, 0.8, 0.1, 0.2] indicating a probability value for each attribute from the probability information about the first user, and may obtain a vector [0.2, 0.7, 0.8, 0.3, 0.5, 0.8, 0. 1, 0.6] indicating a probability value for each attribute from the probability information about the second user. Subsequently, the processor 120 may calculate the similarity between the two obtained vectors. Various techniques such as cosine similarity, Euclidean distance, and Jaccard similarity may be used to calculate the similarity between the two vectors. When the similarity between the two vectors is calculated, the processor 120 may identify whether the probability information about the second user is similar to the probability information about the first user based on whether the calculated similarity is equal to or greater than a threshold value.

As another example, the processor 120 may use a vector indicating the probability value for each attribute as well as a vector indicating the probability value for each sub-attribute in the probability information about each user to calculate the similarity. In particular, the highest probability value among the probability values for each of the sub-attributes may be used to obtain a vector that is the target of similarity calculation.

When the probability information about the second user is similar to the probability information about the first user, the processor 120 may identify the probability information about the second user as the second probability information, and identify the second user as a user with similar tendencies to the first user.

When the second user is identified, the processor 120 may provide at least one recommended content for the first user based on third data corresponding to (or indicating) the second user's access history for a plurality of contents. In particular, the processor 120 may provide, based on the third data, a content of a type that is not included in the first user's access history among a plurality of types as one of the at least one recommended content.

The above has described an embodiment related to comparing probability information of the first user with that of other users, but it is also possible to identify the second user by comparing score information of the first user with that of other users, and to use the third data of the second user to recommend content for the first user.

According to the embodiments described above with reference to FIG. 5, the electronic device 100 may provide recommended content to the first user by using the access history of the second user who has similar tendencies or interests to the first user. Accordingly, the electronic device 100 may provide even a type of content that the first user has not accessed as recommended content by using the access history of the second user, and thus the diversity of recommended content can be significantly improved.

FIG. 6 is a view provided to explain a user interface according to one or more embodiments.

As described above, in one or more embodiments, the processor 120 may sequentially provide recommended content or may control how the recommended content is displayed according to the priority of the score information.

In one or more embodiments, the processor 120 may display the first content and the second content together as recommended content within the user interface, and may adjust the position of the first object corresponding to the first content to be higher or to the left than the second object corresponding to the second content. In this case, the processor 120 may adjust the size of the first object corresponding to the first content to be larger than the second object corresponding to the second content.

For example, when the score for VOD content A (610) is 0.87, the score for music content B (620) is 0.57, and the score for broadcast content C (630) is 0.55, the processor 120 may display VOD content A (610), music content B (620), and broadcast content C (630) together as recommended content within the user interface.

In the above example, the processor 120 may display an object corresponding to VOD content A (610) at the top of an area where recommended content is displayed in the user interface, as illustrated in FIG. 6, and may display an object corresponding to music content B (620) and an object corresponding to broadcast content C (630) below VOD content A (610).

In addition, as illustrated in FIG. 6, the processor 120 may display the size of an object corresponding to VOD content A (610) within the user interface to be larger than the size of an object corresponding to music content B (620) and an object corresponding to broadcast content C (630). The processor 120 may also adjust the size of an object corresponding to recommended content in proportion to the size of the score. In one or more examples, the user interface illustrated in FIG. 6 may be updated in real-time. For example, the user interface may be displayed providing recommended content. Subsequently, while the user interface is displayed, the recommended content may be updated in real-time based on an update to an access history of one or more other users.

The processor 120 may adjust not only the position and size of the object corresponding to the content, but also the color and graphic effects of the object corresponding to the content.

Meanwhile, as illustrated in the lower part of FIG. 6, the processor 120 may display a message such as “Are you satisfied with the recommended content?” in one area (640) of the user interface. Subsequently, when information about user feedback for selecting “Satisfied” or “Dissatisfied” is received, the processor 120 may train the neural network model 1010 based on the information about the user feedback. Even if not directly received in the user feedback, the processor 120 may estimate user satisfaction based on whether the user accesses the recommended content, and train the neural network model 1010 based on the estimated user satisfaction.

According to the embodiment described above with reference to FIG. 6, the electronic device 100 may provide recommended content to the user together with information about the priority of each recommended content. Accordingly, the electronic device 100 may induce the user's access to and feedback on the recommended content, and further improve the effectiveness of providing the recommended content by retraining the neural network model 1010.

FIG. 7 is a block diagram illustrating a configuration of the electronic device 100 in detail according to one or more embodiments.

As illustrated in FIG. 7, the electronic device 100 may further include a communicator 130, an input unit 140, an output unit 150, and an interface unit 160 in addition to the memory 110 and the processor 120. However, the configurations illustrated in FIGS. 1 and 7 are merely examples, and it is to be understood that new configurations may be added or some configurations may be omitted in addition to the configurations illustrated in FIGS. 1 and 7 when implementing the present disclosure.

The communicator 130 includes a circuit, and may perform communication with an external device. Specifically, the processor 120 may receive various data or information from an external device connected through the communicator 130, and may also transmit various data or information to the external device.

The communicator 130 may include at least one of a Wi-Fi module, a Bluetooth module, a wireless communication module, an NFC module, or a Ultra-Wide Band (UWB) module. Specifically, the Wi-Fi module and the Bluetooth module may perform communication in a Wi-Fi manner and a Bluetooth manner, respectively. When using a Wi-Fi module or a Bluetooth module, various connection information such as an SSID or the like may be transmitted and received first, and various information may be transmitted and received after establishing a communication connection using the connection.

Further, the wireless communication module may perform communication according to various communication standards such as IEEE, Zigbee, 3rd Generation (3G), 3rd Generation Partnership Project (3GPP), Long Term Evolution (LTE), 5th Generation (5G), etc. The NFC module may perform communication via a Near Field Communication (NFC) scheme using the 13.56 MHz band among various RF-ID frequency bands such as 135 kHz, 13.56 MHz, 433 MHz, 860-960 MHz, 2.45 GHz, etc. In addition, the UWB module may accurately measure the time of arrival (ToA), the time when the pulse reaches the target, the angle of arrival (AoA), the angle of arrival of the pulse at the transmitting device through communication between UWB antennas, enabling precise distance and location recognition within an error range of tens of centimeters indoors.

In one or more embodiments, when information about recommended content is obtained, the processor 120 may control the communicator 130 to transmit information about at least one recommended content to an external device, such as a user terminal of a user. Accordingly, information about at least one recommended content may be provided to the user through a display, speaker, or the like of the external device. In addition, when information about user feedback is received from the user terminal through the communicator 130, the processor 120 may train the neural network model 1010 based on the information about the user feedback.

In addition, the processor 120 may obtain user data, second data, data on the neural network model 1010, probability information, score information, information about recommended content, etc. by receiving such data from an external device through the communicator 130.

The input unit 140 includes a circuit, and the processor 120 may receive a user command for controlling the operation of the electronic device 100 through the input unit 140. Specifically, the input unit 140 may be configured with components such as a microphone, a camera, and a remote control signal receiving unit. In addition, the input unit 140 may be implemented in a form in which it is included in the display as a touch screen. In particular, the microphone may receive a voice signal and convert the received voice signal into an electric signal.

In one or more embodiments, the processor 120 may receive, via the input unit 140, a user input for requesting recommended content, a user input for requesting a change in recommended content, user feedback on recommended content, etc.

When the input unit 140 includes a microphone, the processor 120 may receive a voice signal corresponding to a user input through the microphone, and may obtain a user input corresponding to the voice signal using a voice recognition model, a natural language understanding model, etc.

The microphone may be included not only in the input unit 140 of the electronic device 100, but may also be included in an external device. When the microphone is included in the external device, the microphone included in the external device may receive an analog voice signal, convert the received analog voice signal into a digital voice signal, and transmit the converted voice signal to the electronic device 100. In addition, the electronic device 100 may receive a voice signal from the external device through the communicator 130.

In this case, the electronic device 100 may perform communication with an external device by using at least one of communication modules, such as a Wi-Fi module, a Bluetooth module, a wireless communication module, an NFC module, and a UWB (Ultra-Wide Band) module, included in the communicator 130. When performing communication with multiple external devices, different communication modules may be used for each of the multiple external devices, or the same communication module may be used.

For example, the external device may be a remote control device (i.e., a remote controller) for controlling the electronic device 100, and may also be a device capable of installing an application for controlling a smart phone, an artificial intelligence speaker, or other electronic devices connected to the electronic device 100. In this case, the external device may transmit a control signal and/or a voice signal to the electronic device 100 using the application for controlling the electronic device 100. The output unit 150 includes a circuit, and the processor 120 may output various functions that the electronic device 100 may perform through the output unit 150. In addition, the output unit 150 may include at least one of a display, a speaker, or an indicator.

The display may output image data under the control of the processor 120. Specifically, the display may output an image previously stored in the memory 110 under the control of the processor 120. In particular, the display according to one or more embodiments of the present disclosure may display a user interface stored in the memory 110. The display may be implemented as a Liquid Crystal Display Panel (LCD), an Organic Light Emitting Diodes (OLE), etc., and in some cases, the display may also be implemented as a flexible display, a transparent display, etc. However, the display according to the present disclosure is not limited to a specific type.

The speaker may output audio data under the control of the processor 120. The indicator may be turned on under the control of the processor 120. Specifically, the indicator may be turned on in various colors under the control of the processor 120. For example, the indicator may be implemented as a Light Emitting Diodes (LED), a Liquid Crystal Display Panel (LCD), a Vacuum Fluorescent Display (VFD), etc., but is not limited thereto.

In one or more embodiments, when information about recommended content is obtained, the processor 120 may control the output unit 150 to output at least one recommended content.

In one or more embodiments, the processor 120 may control the display to display a user interface including a plurality of objects corresponding to at least one recommended content based on the first score information. Here, the plurality of objects may be arranged in an order of priority within the user interface.

When the output unit 150 includes a speaker, the processor 120 may use a voice synthesis model to obtain voice data corresponding to information about recommended content and control the speaker to output the obtained voice data.

The interface unit 160 may transmit and receive video data and/or audio data in a relationship with an external device. Specifically, the interface unit 160 may include an input port capable of receiving video data and/or audio data from an external device and an output port capable of transmitting video data and/or audio data to the external device. In particular, in case the interface unit 160 can transmit and receive both video data and audio data, input/output ports capable of transmitting and receiving video data and audio data may be implemented separately. The interface unit 160 may connect an electronic device and an external device wiredly through a cable, but may also connect an electronic device and an external device wirelessly.

For example, the interface unit 160 may include a High-Definition Multimedia Interface (HDMI) module, a Universal Serial Bus (USB) module, etc. The HDMI module is one of the uncompressed digital video/audio interface standards, and may provide an interface between an electronic device and an external device providing content. The USB module may provide a communication system between an electronic device and an external device providing content using a predefined input/output standard protocol. In addition to the HDMI module and the USB module, the interface unit 160 may of course be implemented as various modules for providing input/output of video/audio data between the electronic device and the external device, such as a Display Port (DP) module, an RGB module, a Digital Visual Interface (DVI) module, and a thunderbolt module.

In particular, in one or more embodiments, the processor 120 may control the interface unit 160 to transmit information about a user interface to an external device to display a user interface including a plurality of objects corresponding to at least one recommended content on the display of the external device.

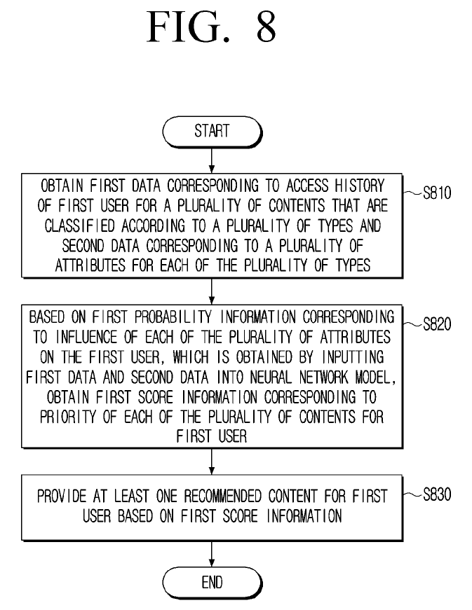

FIG. 8 is a flowchart illustrating a method of controlling the electronic device 100 according to one or more embodiments.

Referring to FIG. 8, the electronic device 100 may obtain first data corresponding to a first user's access history for a plurality of contents classified according to a plurality of types and second data corresponding to a plurality of attributes for each of the plurality of types (S810).

The electronic device 100 may obtain the first data and the second data by loading the first data and the second data stored in the memory 110 of the electronic device 100. The electronic device 100 may also obtain the first data and the second data by receiving the first data and the second data from an external device.

The electronic device 100 may obtain first score information corresponding to the priority of each of the plurality of contents for the first user based on first probability information corresponding to the influence of each of the plurality of attributes on the first user, which is obtained by inputting the first data and the second data into a neural network model (S820).

Specifically, the electronic device 100 may input the first data and the second data into the trained neural network model 1010 to obtain the first probability information indicating the influence of each of the plurality of attributes on the first user.

In one or more embodiments, the electronic device 100 may obtain first probability values by synthesizing second probability values for each of the plurality of attributes.

In one or more embodiments, when the first user accesses first content among a plurality of contents, the electronic device 100 may obtain first probability information based on increasing a probability value for at least one attribute corresponding to the first content among the plurality of attributes through the neural network model 1010.

In one or more embodiments, when the first user accesses the first content among the plurality of contents, and the first content is recommended content provided based on one of the plurality of attributes, the electronic device 100 may obtain the first probability information based on increasing a probability value for the one attribute through the neural network model 1010.

The electronic device 100 may obtain first score information indicating a priority of each of the plurality of contents for the first user based on the first probability information.

In one or more embodiments, the electronic device 100 may obtain the first score information indicating a priority of each of the plurality of contents for the first user by assigning a higher score to contents including more attributes/sub-attributes that the user considers more when selecting the contents, based on at least one of a probability value for each of a plurality of attributes or a probability vale for each of a plurality of sub-attributes included in the first probability information.

In one or more embodiments, the electronic device 100 may obtain the first score information by using only the probability value for each of the plurality of attributes, without using the probability value for each of the plurality of sub-attributes included in the first probability information. In addition, the electronic device 100 may obtain the first score information by using the probability value for each of the plurality of attributes together with the probability value corresponding to the sub-attribute having the highest probability value among the probability values for each of the plurality of sub-attributes included in the first probability information.

The electronic device 100 may provide a plurality of recommended contents to the first user based on the first score information (S830).

In one or more embodiments, the electronic device 100 may identify (or determine) at least one recommended content for the first user based on the first score information, and may provide the identified recommended content.

In one or more embodiments, the electronic device 100 may provide at least one recommended content so that the at least one recommended content is displayed in a priority order on the user interface based on the first score information.

The controlling method of the electronic device 100 according to the above-described embodiment may be implemented as a program and provided to the electronic device 100. In particular, the program including the controlling method of the electronic device 100 may be stored and provided in a non-transitory computer readable medium.

Specifically, in a non-transitory computer-readable recording medium including a program for executing a controlling method of the electronic device 100, the controlling method of the electronic device 100 may include obtaining first data indicating an access history of a first user for a plurality of contents classified according to a plurality of types and second data indicating a plurality of attributes for each of the plurality of types, inputting the first data and the second data into a trained neural network model to obtain first probability information indicating an influence of each of the plurality of attributes on the first user, obtaining first score information indicating a priority of each of the plurality of contents for the first user based on the first probability information, and providing at least one recommended content for the first user based on the first score information.

In the above, the controlling method of the electronic device 100 and the computer-readable recording medium including a program for executing the controlling method of the electronic device 100 have been briefly described, but this is only to omit redundant description, and various embodiments of the electronic device 100 may of course also be applied to the controlling method of the electronic device 100 and the computer-readable recording medium including a program for executing the controlling method of the electronic device 100.

The function related to artificial intelligence according to the present disclosure is operated through the processor 120 and the memory 110 of the electronic device 100.

The processor 120 may consist of one or a plurality of processors 120. In this case, the one or more processors 120 may include at least one of a central processing unit (CPU), a graphic processing unit (GPU), or a neural processing unit (NPU), but are not limited to examples of the above-described processors 120.

The CPU is a generic-purpose processor 120 which may perform not only general calculations but also artificial intelligence calculations, and may efficiently execute complex programs through a multi-layered cache structure. The CPU may be advantageous for a serial processing method that enables organic linkage between the previous calculation result and the next calculation result through sequential calculation. The generic-purpose processor 120 is not limited to the above examples except for a case where the processor 120 is specified as the above-mentioned CPU.

The GPU is a processor 120 for large-scale operations such as floating-point operations used for graphics processing, and may perform the large-scale operations in parallel by integrating a large number of cores. In particular, the GPU may be advantageous for a parallel processing method such as a convolution operation or the like, compared to the CPU. In addition, the GPU may be used as a co-processor 120 to supplement a function of the CPU. The processor 120 for the large-scale operations is not limited to the above example except for a case where the processor 120 is specified as the above-mentioned GPU.

The NPU is a processor 120 specialized in artificial intelligence calculation using an artificial neural network, and each layer constituting the artificial neural network may be implemented as hardware (e.g., silicon). In this case, the NPU is specially designed based on requirements of a company, and may thus have a lower degree of freedom compared to the CPU or the GPU, but the NPU may efficiently process the artificial intelligence calculation required by the company. Meanwhile, as the processor 120 specialized for the artificial intelligence calculation, the NPU may be implemented in various forms such as a tensor processing unit (TPU), an intelligence processing unit (IPU), or a vision processing unit (VPU). The artificial intelligence processor 120 is not limited to the above example except for a case where the processor 120 is specified as the above-mentioned NPU.

In addition, the one or more processors 120 may be implemented as a system on chip (SoC). Here, the SoC may further include the memory 110 and a network interface such as a bus for data communication between the processor 120 and the memory 110 in addition to the one or more processors 120.

In case that the system on chip (SoC) included in the electronic device 100 includes a plurality of processors 120, the electronic device 100 may use some of the plurality of processors 120 to perform the artificial intelligence calculation (e.g., calculation related to the learning or inference of an artificial intelligence model). For example, the electronic device 100 may perform the artificial intelligence calculation by using at least one of the GPU, NPU, VPU, TPU, or a hardware accelerator that is specialized for the artificial intelligence calculation such as convolution calculation and matrix multiplication calculation among the plurality of processors 120. However, this is only an example, and the artificial intelligence calculation may be processed using the generic-purpose processor 120 such as the CPU.

In addition, the electronic device 100 may perform calculation for a function related to the artificial intelligence by using multi-cores (e.g., dual-core or quad-core) included in one processor 120. In particular, the electronic device 100 may perform the artificial intelligence calculation such as the convolution calculation and the matrix multiplication calculation in parallel using the multi-cores included in the processor 120.

The one or more processors 120 may control to process the input data based on a predefined operation rule or an artificial intelligence model stored in the memory 110. The predefined operation rule or artificial intelligence model may be acquired by the learning.

Here, "acquired by the learning" may indicate that the predefined operation rule or artificial intelligence model of a desired feature is acquired by applying a learning algorithm to a lot of learning data. Such learning may be performed on a device itself where the artificial intelligence is performed according to an embodiment, or by a separate server/system.

The artificial intelligence model may consist of a plurality of neural network layers. At least one layer has at least one weight value, and calculation of the layer may be performed through an operation result of a previous layer and at least one defined operation. Examples of the neural network may include a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, and a transformer, but the neural network in this disclosure is not limited to the above examples except for a case where a type of the neural network is specified.

The learning algorithm is a method of training a preset target device (e.g., a robot) by using a large number of learning data for the preset target device to make a decision or a prediction by itself. The learning algorithms may include, for example, a supervised learning algorithm, an unsupervised learning algorithm, a semi-supervised learning algorithm, or a reinforcement learning algorithm, but the learning algorithm of the disclosure is not limited to the above-described examples, unless specified otherwise.

The machine-readable storage medium may be provided in the form of a non-transitory storage medium. Here, the term ‘non-transitory’ means that the storage medium is tangible without including a signal (e.g. electromagnetic waves), and does not distinguish whether data are semi-permanently or temporarily stored in the storage medium. For example, the ‘non-transitory storage medium’ may include a buffer in which data is temporarily stored.

According to one or more embodiments, the methods according to various embodiments disclosed in this document may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore^{TM}) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory 110 of a relay server or may be temporarily generated.

Further, the components (e.g., modules or programs) according to various embodiments described above may include a single entity or a plurality of entities, and some of the corresponding sub-components described above may be omitted or other sub-components may be further included in the various embodiments. Alternatively or additionally, some components (e.g., modules or programs) may be integrated into one entity and perform the same or similar functions performed by each corresponding component prior to integration.

Operations performed by the modules, the programs, or the other components according to the various embodiments may be executed in a sequential manner, a parallel manner, an iterative manner, or a heuristic manner, or at least some of the operations may be performed in a different order or be omitted, or other operations may be added.

Meanwhile, terms “unit” or “module” used in the disclosure may include units configured by hardware, software, or firmware, and may be used compatibly with terms such as, for example, logics, logic blocks, parts, circuits, or the like. The “unit” or “module” may be an integrally configured part or a minimum unit performing one or more functions or a part thereof. For example, the module may be configured by an application-specific integrated circuit (ASIC).

Various embodiments of the present disclosure may be implemented in software including an instruction stored in a machine-readable storage medium (e.g., computer). The machine may be a device that invokes the stored instruction from the storage medium and can be operated based on the invoked instruction, and may include an electronic apparatus (e.g., electronic device 100) according to the embodiments disclosed herein.

In case that the instruction is executed by the processor, the processor may directly perform a function corresponding to the instruction or other components may perform the function corresponding to the instruction under control of the processor. The instruction may include codes generated or executed by a compiler or an interpreter.

Although example embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic device comprising:
memory storing at least one instruction; and
at least one processor operatively coupled to the memory,
wherein the at least one instruction, when executed by the at least one processor individually or collectively, causes the electronic device to:
obtain first data corresponding to an access history of a first user for a plurality of contents that are classified according to a plurality of types,
obtain second data corresponding to a plurality of attributes for each of the plurality of types,
obtain first score information corresponding to a priority of each of the plurality of contents for the first user based on first probability information corresponding to an influence of each of the plurality of attributes on the first user, the first probability information being obtained by inputting the first data and the second data into a neural network model, and
provide, via a display, at least one recommended content for the first user based on the first score information.

2. The electronic device as claimed in claim 1, wherein the at least one instruction, when executed by the at least one processor individually or collectively, further causes the electronic device to provide the at least one recommended content such that the at least one recommended content is displayed on a user interface provided in the display according to an order of the priority based on the first score information.

3. The electronic device as claimed in claim 1, wherein the at least one instruction, when executed by the at least one processor individually or collectively, further causes the electronic device to obtain the first score information based on the priority of each of the plurality of contents for the first user without considering a priority of each of the plurality of types for the first user.

4. The electronic device as claimed in claim 1, wherein the first probability information comprises (i) first probability values indicating the influence of each of the plurality of attributes on the first user and (ii) second probability values indicating an influence of each of a plurality of sub-attributes that distinguish each of the plurality of attributes on the first user; and
wherein the at least one instruction, when executed by the at least one processor individually or collectively, causes the electronic device to obtain the first probability values based on the second probability values for each of the plurality of attributes.

5. The electronic device as claimed in claim 1, wherein the neural network model is configured to, based on the first user accessing first content among the plurality of contents, obtain the first probability information based on increasing a probability value for at least one attribute corresponding to the first content.

6. The electronic device as claimed in claim 5, wherein the neural network model is configured to, based on the first content being recommended content provided based on one of the plurality of attributes, obtain the first probability information based on increasing the probability value for the at least one attribute corresponding to the first content.

7. The electronic device as claimed in claim 6, wherein the neural network model is configured to, by assigning a weight to the at least one attribute corresponding to the first content based on time information that is included in the first data and indicates a time of an access, obtain the first probability information.

8. The electronic device as claimed in claim 1, wherein the at least one instruction, when executed by the at least one processor individually or collectively, further causes the electronic device to:
identify second probability information among probability information about each of a plurality of users having a similarity value with the first probability information that is equal to or greater than a threshold value;
identify a second user corresponding to the second probability information among the plurality of users; and
provide the at least one recommended content for the first user based on third data corresponding to an access history of the second user for the plurality of contents.

9. The electronic device as claimed in claim 8, wherein the at least one instruction, when executed by the at least one processor individually or collectively, further causes the electronic device to provide a type of content that is not included in the access history of the first user among the plurality of types as one of the at least one recommended content based on the third data.

10. The electronic device as claimed in claim 1, further comprising:
communication circuitry,
wherein the at least one instruction, when executed by the at least one processor individually or collectively, further causes the electronic device to:
control the communication circuitry to transmit information about the at least one recommended content to a user terminal of a user; and
based on information about user feedback being received from the user terminal through the communication circuitry, train the neural network model based on the information about the user feedback.

11. The electronic device as claimed in claim 1, further comprising:
the display,
wherein the at least one instruction, when executed by the at least one processor individually or collectively, further causes the electronic device to:
control the display to display a user interface including a plurality of objects corresponding to the at least one recommended content based on the first score information; and
wherein the plurality of objects are arranged according to an order of the priority within the user interface.

12. A controlling method of an electronic device, the method comprising:
obtaining first data corresponding to an access history of a first user for a plurality of contents that are classified according to a plurality of types;
obtaining second data corresponding to a plurality of attributes for each of the plurality of types;
obtaining first score information corresponding to a priority of each of the plurality of contents for the first user based on first probability information corresponding to an influence of each of the plurality of attributes on the first user, the first probability information being obtained by inputting the first data and the second data into a neural network model; and
providing, on a display, at least one recommended content for the first user based on the first score information.

13. The method as claimed in claim 12, wherein the providing recommended content comprises providing the at least one recommended content such that the at least one recommended content is displayed on a user interface provided in the display according to an order of the priority based on the first score information.

14. The method as claimed in claim 12, wherein the obtaining first score information comprises obtaining the first score information based on the priority of each of the plurality of contents for the first user without considering a priority of each of the plurality of types for the first user.

15. The method as claimed in claim 12, wherein the first probability information comprises (i) first probability values indicating the influence of each of the plurality of attributes on the first user and (ii) second probability values indicating an influence of each of a plurality of sub-attributes that distinguish each of the plurality of attributes on the first user; and
wherein the obtaining the first probability information comprises obtaining the first probability values based on the second probability values for each of the plurality of attributes.

16. A non-transitory computer readable medium, having instructions stored therein, which when executed by at least one processor of an electronic device cause the electronic device to perform a method comprising:
obtaining first data corresponding to an access history of a first user for a plurality of contents that are classified according to a plurality of types;
obtaining second data corresponding to a plurality of attributes for each of the plurality of types;
obtaining first score information corresponding to a priority of each of the plurality of contents for the first user based on first probability information corresponding to an influence of each of the plurality of attributes on the first user, the first probability information being obtained by inputting the first data and the second data into a neural network model; and
providing, on a display, at least one recommended content for the first user based on the first score information.

17. The non-transitory computer readable medium as claimed in claim 16, wherein the method further comprises providing the at least one recommended content such that the at least one recommended content is displayed on a user interface provided in the display according to an order of the priority based on the first score information.

18. The non-transitory computer readable medium as claimed in claim 16, wherein the method further comprises obtaining the first score information based on the priority of each of the plurality of contents for the first user without considering a priority of each of the plurality of types for the first user.

19. The non-transitory computer readable medium as claimed in claim 16, wherein the first probability information comprises (i) first probability values indicating an influence of each of the plurality of attributes on the first user and (ii) second probability values indicating the influence of each of a plurality of sub-attributes that distinguish each of the plurality of attributes on the first user; and
wherein the method further comprises obtaining the first probability values based on the second probability values for each of the plurality of attributes.

20. The non-transitory computer readable medium as claimed in claim 16, wherein the neural network model is configured to, based on the first user accessing first content among the plurality of contents, obtain the first probability information based on increasing a probability value for at least one attribute corresponding to the first content.
